(19) United States
(12) Patent Application Publication
(10) Pub. No.: US 2024/0392121 A1
(43) Pub. Date: Nov. 28, 2024

(54) Fluorine-Free Polymer Processing Aids

(71) Applicant: ExxonMobil Chemical Patents Inc., Baytown, TX (US)

(72) Inventors: Danny VAN HOYWEGHEN, Machelen (BE); Michael A. LEAF, Baytown, TX (US)

(21) Appl. No.: 18/690,824

(22) PCT Filed: Sep. 22, 2022
(86) PCT No.: PCT/US2022/076869

§ 371 Date: Mar. 11, 2024

Related U.S. Application Data
(60) Provisional application No. 63/261,908, filed on Sep. 30, 2021.

(51) Int. Cl. C08L 23/08

(52) U.S. Cl. CPC C08L 23/0815; C08L 2205/06; C08L 2207/066

(57) ABSTRACT

Provided herein are polymer compositions comprising a polymer and a surfactant. The surfactant can serve as a polymer processing aid (PPA), and can include a sorbitan ester and/or a polysorbate, preferably a polysorbate. The polymer composition can optionally include other additives, as well. The polymer can be a C2-Ce olefin homopolymer or a copolymer of two or more C2-C20 a-olefins, and the polymer composition can take the form of polymer pellets; a polymer melt; reactor-grade polymer granules and/or polymer slurries; or other form of polymer composition containing the PPA and optionally one or more other additives. The polymer composition is preferably free or substantially free of fluorine, including fluoropoly mer-based PPAs.

### CROSS-REFERENCE TO RELATED APPLICATIONS

This application claims the benefit of U.S. Provisional Application 63/261,908 filed Sep. 30, 2021 entitled “Fluorine-Free Polymer Processing Aids”, and also claims the benefit of U.S. Provisional Application 63/266,782 filed Jan. 14, 2022 entitled “Fluorine-Free Polymer Processing Aids”, and also claims the benefit of U.S. Provisional Application 63/267,640 filed Feb. 7, 2022 entitled “Fluorine-Free Polymer Processing Aids Including Polyethylene Glycols”, and also claims the benefit of U.S. Provisional Application 63/309,859 filed Feb. 14, 2022 entitled “Fluorine-Free Polymer Processing Aids Including Polyethylene Glycols”, and also claims the benefit of U.S. Provisional Application 63/309,871 filed Feb. 14, 2022 entitled “Fluorine-Free Polymer Processing Aid Blends”, and also claims the benefit of U.S. Provisional Application 63/366,678 filed Jun. 20, 2022 entitled “Fluorine-Free Polymer Processing Aid Blends”, and also claims the benefit of U.S. Provisional Application 63/367,241 filed Jun. 29, 2022 entitled “Polyethylene Glycol-Based Polymer Processing Aids”, and also claims the benefit of U.S. Provisional Application 63/367,425 filed Jun. 30, 2022 entitled “Polyethylene Glycol-Based Polymer Processing Aid Masterbatches”, the entireties of which are incorporated by reference herein.

### FIELD

The present disclosure relates to additives for polyolefin polymers (such as polyethylene), as well as the polymers themselves, methods of making them, and articles made therefrom.

### BACKGROUND

Polyolefin polymer compositions are in high demand for many applications, including various films (such as cast films, shrink films, and blown films), sheets, membranes such as geomembranes, sacks, pipes (e.g., polyethylene of raised temperature (PE-RT) pipes, utility pipes, and gas distribution pipes), roto-molded parts, blow-molded flexible bottles or other containers, and various other blow molded/extruded articles such as bottles, drums, jars, and other containers. These applications have been commonly made from, for example, polyethylene polymers.

Polyolefin polymers are most commonly produced and sold as pellets, formed in post-polymerization reactor finishing processes (such as extrusion of polymer product that is in an at least partially molten state, followed by pelletization). Additives are commonly blended into the polymer product as part of this finishing process, such that the polymer pellets comprise the polymer itself and one or more additives.

Common additives, particularly for polymers such as polyethylenes intended for use as films, sacks, and other similar articles, include polymer processing aids (PPAs), which help make the pellets easier to manipulate in downstream manufacturing processes (such as extrusion, rolling, blowing, casting, and the like). Adequate amounts of PPA, among other things, help eliminate melt fractures in films made from the polymer pellets. This is particularly so for polymer pellets exhibiting relatively higher viscosity in extrusion processes. Melt fracture is a mechanically-induced melt flow instability which occurs, e.g., at the exit of an extrusion die and typically in conditions of high shear rate. Pinhole, linear, and annular die geometries are among those that can induce melt fracture. There are different mechanical regimes that describe PE melt fracture, but all manifest as a very rough polymer surface which persists as the polymer crystallizes. Commonly in the blown film industry, a rough array of sharkskin like patterns develop on the film surface, often with a characteristic size from the mm to cm scale, and they depend on both the flow profile and rheology of the polyolefin polymer (e.g., polyethylene).

Melt fracture can adversely affect film properties, distort clarity, and reduce gauge uniformity. Thus, melt fracture-prone polymer grades, as noted, often rely on a PPA.

The most common PPAs are or include fluoropolymers (fluorine-containing polymers). It is, however, desired to find alternative PPAs that do not include fluoropolymers and/or fluorine, while maintaining the effectiveness of fluoropolymer-based PPAs in preventing melt fractures.

Some references of potential interest in this regard include: U.S. Pat. Nos. 10,982,079; 10,242,769; 10,544,293; 9,896,575; 9,187,629; 9,115,274; 8,552,136; 8,455,580; 8,728,370; 8,388,868; 8,178,479; 7,528,185; 7,442,742; 6,294,604; 5,015,693; and 4,540,538; U.S. Patent Publication Nos. 2005/0070644, 2008/0132654, 2014/0182882, 2014/0242314, 2015/0175785, 2020/0325314; as well as WO2011/028206, CN104558751, CN112029173, KR10-2020-0053903, CN110317383, JP2012009754A, WO2017/077455, CN108481855, CN103772789.

### SUMMARY

The present disclosure relates to polymer compositions, their methods of manufacture, and articles including and/or made from the polymer compositions. In a particular focus, the polymer compositions may be polyolefin compositions, such as polyethylene compositions. The polymer compositions can also include a PPA that is free or substantially free of fluorine; and, similarly, the polymer compositions can be free or substantially free of fluorine. In this context, “substantially free” permits trace amounts (e.g., 10 ppm or less, preferably 1 ppm or less, such as 0.1 ppm or less) of fluorine, e.g., as an impurity, but well below the amount that would intentionally be included in a polymer composition via such additives (e.g., about 100 ppm of fluorine atoms by mass of polymer product in a typical case where such additives are included). In various embodiments, the polymer compositions can be, e.g., polymer pellets; a polymer melt (as would be formed in an extruder such as a compounding extruder); reactor-grade polymer granules and/or polymer slurries; or other form of polymer composition containing the PPA and optionally one or more other additives.

The present disclosure also relates to films and/or other end-use articles made from such polymer compositions, and in particular instances can relate to cast or blown films, preferably blown films. Thus, the polyolefin compositions (e.g., polymer pellets) of various embodiments, and/or films or other articles made therefrom (e.g., blown films), are themselves free or substantially free of fluorine (or, at a minimum, free or substantially free of fluorine-based PPA). A fluorine-based PPA, as used herein, is a polymer processing aid or other polymeric additive containing fluorine.

The present inventors have found that a surfactant (a compound comprising a lipophilic moiety and a hydrophilic moiety) is an advantageous replacement of fluorine-based PPAs in polyolefin compositions; and, in particular embodiments, the surfactant-based PPA comprises a surfactant that includes a lipophilic tail and a hydrophilic head. More specifically, a preferred surfactant comprises, consists essentially of, or consists of, a sorbitan ester, or a polyoxyethylene derivative thereof (also known as a polysorbate). Thus, polyolefin compositions of various embodiments comprise an olefin-based polymer and a surfactant comprising a sorbitan ester or a polyoxyethylene derivative of a sorbitan ester. It will be noted that the skilled artisan may desire to choose from between these two sub-classes of the surfactant based upon particular objectives of deployment of the PPA, keeping in mind that in the sorbitan esters, the lipophilic character is more prominent; while in the polyoxyethylene derivatives thereof (i.e., polysorbates), the hydrophilic character predominates. See, e.g., Schiweck et al., Sugar Alcohols, in ULLMAN'S ENCYCLOPEDIA OF INDUSTRIAL CHEMISTRY, 3.4 (Wiley-VCH Jan. 15, 2012) (citing F. R. Benson in M. Schick (ed.): Nonionic Surfactants, Marcel Dekker, New York 1967, p. 247). In various embodiments discussed in more detail herein, the polyoxyethylene derivatives are preferred surfactants for use as PPAs in polymer compositions. And, while polymer compositions of certain embodiments may include other additives (even other PPAs such as fluorine-based PPAs) in addition to the surfactant-based PPA, in preferred embodiments—as just noted above—the polymer composition is free or substantially free of fluorine.

The surfactant can be present in the polymer composition in amounts ranging from about 200 ppm to about 5000 ppm, on the basis of mass of polymer in the polymer composition, more preferably about 200 ppm to about 2000 ppm, or about 400 ppm to about 1200 ppm, although lower amounts (e.g., 50 or 100 ppm to 200, 300, 400, or 500 ppm) can be employed where other PPAs will be used (e.g., conventional fluorine-based PPAs or, more preferably, other PPAs free or substantially free of fluorine). As noted, other additives optionally can also be present in the polymer composition (e.g., antioxidants, stabilizers such as UV stabilizers, catalyst neutralizers, and other additives known in the art of polymerization). The polymer and surfactant-based PPA included in polymer compositions of various embodiments are discussed in more detail below.

### BRIEF DESCRIPTION OF THE DRAWINGS

FIG. 1 is a schematic conceptually illustrating streaks of melt fractures and stripes of regions with melt fractures eliminated in a blown film during extrusion.

FIG. 2 is a graph showing melt fractures over time in blown films made using various PPAs in connection with the Examples

FIG. 3 is a graph showing melt fractures over time in blown films made using various PPAs in connection with the Examples

FIG. 4 is a graph showing melt fractures over time in blown films made using various PPAs in connection with the Examples.

FIG. 5 is a graph showing melt fractures over time in blown films made using various PPAs in connection with the Examples.

FIG. 6a is a chart showing a comparison of properties among some films made using various PPAs in connection with the Examples.

FIG. 6b is a graph showing heat seal strength of some films made using various PPAs in connection with the Examples.

FIG. 6c is a graph showing hot tack peak force of some films made using various PPAs in connection with the Examples.

### DETAILED DESCRIPTION

### Definitions

For the purposes of the present disclosure, various terms are defined as follows.

The term “polyethylene” refers to a polymer having at least 50 wt % ethylene-derived units, such as at least 70 wt % ethylene-derived units, such as at least 80 wt % ethylene-derived units, such as at least 90 wt % ethylene-derived units, or at least 95 wt % ethylene-derived units, or 100 wt % ethylene-derived units. The polyethylene can thus be a homopolymer or a copolymer, including a terpolymer, having one or more other monomeric units. A polyethylene described herein can, for example, include at least one or more other olefin(s) and/or comonomer(s).

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 50 wt % to 55 wt %, it is understood that the mer unit in the copolymer is derived from ethylene in the polymerization reaction and said derived units are present at 50 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomencally.

The term “alphα-olefin” or “α-olefin” refers to an olefin having a terminal carbon-to-carbon double bond in the structure thereof R¹R²C═CH₂, where R¹ and R² can be independently hydrogen or any hydrocarbyl group; such as R¹ is hydrogen and R² is an alkyl group. A “linear alphα-olefin” is an alphα-olefin wherein R¹ is hydrogen and R² is hydrogen or a linear alkyl group. For the purposes of the present disclosure, ethylene shall be considered an α-olefin.

As used herein, the term “extruding” and grammatical variations thereof refer to processes that include forming a polymer and/or polymer blend into a melt, such as by heating and/or sheer forces, and then forcing the melt out of a die in a form or shape such as in a film, or in strands that are pelletized. Most any type of apparatus will be appropriate to effect extrusion such as a single or twin-screw extruder, or other melt-blending device as is known in the art and that can be fitted with a suitable die. It will also be appreciated that extrusion can take place as part of a polymerization process (in particular, in the finishing portion of such process) as part of forming polymer pellets; or it can take place as part of the process for forming articles such as films from the polymer pellets (e.g., by at least partially melting the pellets and extruding through a die to form a sheet, especially when combined with blowing air such as in a blown film formation process). In the context of the present disclosure, extrusion in the finishing portion of polymerization processes may be referred to as compounding extrusion, and typically involves feeding additives plus additive-free (reactor grade) polymer to the extruder; while extrusion of polymer to make articles (e.g., extrusion of polymer pellets to make films) takes place conceptually “downstream” (e.g., at a later point, after polymer product has been formed including through compounding extrusion), and typically involves feeding optional additives plus additive-containing polymer to the extruder.

### Polymers

In various embodiments, polymer compositions include one or more polymers, preferably polyolefin polymers. Examples include homopolymers (e.g., homopolymers of a C₂ to C₁₀ α-olefin, preferably a C₂ to C₆ α-olefin). Particular examples of homopolymers include homopolyethylene and polypropylene (hPP). Taking for example homopolyethylene, such a polymer may be produced, e.g., by free radical polymerization in a high-pressure process, resulting typically in a highly branched ethylene homopolymer—often known as LDPE (low density polyethylene), having density less than 0.945 g/cm³, often 0.935 g/cm³ or less, such as within the range from 0.900, 0.905, or 0.910 g/cm³ to 0.920, 0.925, 0.927, 0.930, 0.935, or 0.945 g/cm³. Unless otherwise noted herein, all polymer density values are determined per ASTM D1505. Samples are molded under ASTM D4703-10a, procedure C, and conditioned under ASTM D618-08 (23°+2° C. and 50±10% relative humidity) for 40 hours before testing.

In another example, ethylene monomers may be polymerized via known gas, slurry, and/or solution phase polymerization (e.g., using catalysts such as chromium-based catalysts, or single-site catalysts such as Ziegler-Natta and/or metallocene catalysts, all of which are well known in the art of polymerization and not discussed further herein. Where a more highly linear ethylene homopolymer is produced (e.g., using gas or slurry phase polymerization with any of the above noted catalysts), it may be referred to as HDPE (high density polyethylene), typically having density 0.945 g/cm³ or greater, such as within the range from 0.945 to 0.970 g/cm³.

Yet further polymer examples include copolymers of two or more C₂ to C₄₀ α-olefins, such as C₂ to C₂₀ α-olefins, such as ethylene-α-olefin copolymers, or propylene-α-olefin copolymers (e.g., propylene-ethylene copolymers, or propylene-ethylene-diene terpolymers, sometimes known as EPDMs or PEDMs). Particular examples contemplated herein include copolymers of ethylene and one or more C₃ to C₂₀ α-olefin comonomers, such as C₄ to C₁₂ α-olefin comonomers (with 1-butene, 1-hexene, 1-octene, or mixtures of two or more of them being preferred in some embodiments). An ethylene copolymer (e.g., a copolymer of ethylene and one or more C₃ to C₂₀ α-olefins) can include ethylene-derived units in an amount of at least 80 wt %, or 85 wt %, such as at least 90, 93, 94, 95, or 96 wt % (for instance, in a range from a low of 80, 85, 90, 91, 92, 93, 94, 95, 96, or 97 wt %, to a high of 94, 95, 95.5, 96, 96.5, 97, 97.5, or 98 wt %, with ranges from any foregoing low value to any foregoing high value contemplated (provided the high is greater than the low) based on a total amount of ethylene-derived units and comonomer-derived units. For instance, the ethylene copolymer can include 94 or 95 wt % to 97 or 98 wt % ethylene-derived units based on the total amount of ethylene-derived units and comonomer-derived units. The balance of the copolymer (on the basis of ethylene-derived units and comonomer-derived units) is comprised of the comonomer-derived units. For example, comonomer units (e.g., C₂ to C₂₀ (α-olefin-derived units, such as units derived from butene, hexene, and/or octene) may be present in the ethylene copolymer from a low of 2, 2.5, 3, 3.5, 4, 4.5, 5, or 6 wt %, to a high of 3, 4, 5, 6, 7, 8, 9, 10, 15, or 20 wt %, with ranges from any foregoing low to any foregoing high contemplated (provided the high is greater than the low value).

For ethylene-based, propylene-based, or other α-olefin based copolymers, several suitable comonomers were already noted, although in various embodiments, other α-olefin comonomers are contemplated. For example, the α-olefin comonomer can be linear or branched, and two or more comonomers can be used, if desired. Examples of suitable comonomers include linear C₃-C₂₀ α-olefins (such as butene, hexene, octene as already noted), and α-olefins having one or more C₁-C₃ alkyl branches, or an aryl group. Examples can include propylene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. It should be appreciated that the list of comonomers above is merely exemplary, and is not intended to be limiting. In some embodiments, comonomers include propylene, 1-butene, 1-pentene, 4-methyl-1-pentene, 1-hexene, 1-octene and styrene.

In particular embodiments, the polymer can comprise or can be an ethylene copolymer (per those described above). The ethylene copolymer can be produced in gas, slurry, or solution phase polymerization, and some particularly preferred ethylene copolymers can be produced in gas or slurry phase polymerization. A particular example is a linear-low density polyethylene (LLDPE), a copolymer of ethylene and one or more α-olefins polymerized in the presence of one or more single-site catalysts, such as one or more Ziegler-Natta catalysts, one or more metallocene catalysts, and combinations thereof. Such LLDPE can have density within the range from a low of 0.900, 0.905, 0.907, 0.910 g/cm³ to a high of 0.920, 0.925, 0.930, 0.935, 0.940, or 0.945 g/cm³. LLDPE can be distinguished from the above-mentioned LDPE in several respects, many of which are well known in the art, including the degree of branching (sometimes referred to more specifically as long-chain branching) in the produced polymer, noting that LLDPE has substantially less (often little, if any) long chain branching. In particular embodiments, the polymer of the polymer composition is or includes a metallocene-catalyzed LLDPE (mLLDPE).

### Surfactant-Based Polymer Processing Aids

The polymer compositions of various embodiments also include a surfactant-based PPA, which may in turn include one or more surfactants (e.g., one surfactant or a blend of surfactants; and preferably, where a blend is employed, the blend comprises two or more fluorine-free surfactants).

The present inventors have found that fluorine-free surfactants, comprising a polar head and apolar tail (in other words, a hydrophilic head and lipophilic tail), can act similarly to conventional fluorine-based PPAs in a polymer melt. In particular, it is believed that such a surfactant can migrate out of the polymer melt and form a protective coating on the metal surface of the die wall when the polymer melt is being extruded through the die. The protective coating effectively lubricates the polymer melt by reducing shear stress near the wall. This change leads to more uniform flow profile at the die exit, and the material is thus less prone to flow instability.

Thus, polymer compositions of some embodiments include a surfactant comprising a hydrophilic head and a lipophilic tail. As used herein, a hydrophilic head refers to a moiety having a polar, or hydrophilic, nature; and a lipophilic tail refers to a moiety, having an apolar, or lipophilic (alternatively, hydrophobic) nature. A lipophilic tail is so-named because it typically comprises a hydrocarbon chain of at least 3, 4, or 5 carbons in length. The heads and tails of surfactants can be composed of many different types and sizes of molecules, which are often adjusted to tune their solubility. Surfactants are a suitable option as a PPA because they can be adjusted for their solubility in a polymer melt (e.g., melt polyethylene polymer); they can be apolar enough to be homogenized into the polymer of the melt, but polar enough to tend to migrate to metallic surfaces through which the melt is being passed, to form lubricating coatings.

One class of surfactants that gains particular focus herein is sorbitan esters, comprising an apolar carboxylic acid (a “lipophilic tail”) attached by ester linkage to a polar sorbitan group (the “hydrophilic head” of such molecules). Also of interest are polyoxyethylene derivatives of sorbitan esters, which include a plurality of polyoxyethylene oligomers chemically substituted onto the sorbitan group. These polyoxyethylene derivatives of sorbitan esters may also be referred to as polysorbates.

More particularly, the polyoxyethylene derivative of sorbitan ester (also referred to as a polysorbate) can take the form of Formula (I):

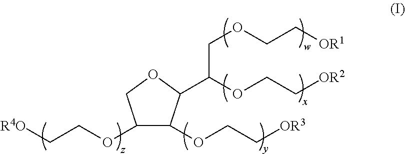

where: one of R¹-R⁴ is a straight chain fatty acid moiety, and the other three of R¹-R⁴ are each hydrogen; and w, x, y, and z are integers such that 10≤w+x+y+z≤40; preferably 15≤w+x+y+z≤25; more preferably w+x+y+z=20. The straight chain fatty acid moiety is preferably of the formula (C═O)(CH₂)ₐCH₃, where a is an integer between 10 and 25 (inclusive), preferably between 12 and 18 (inclusive), although the fatty acid moiety may instead include a double-bond along the hydrocarbon chain (that is, it may include a monounsaturation), such that the formula is (C═O)(CH₂)_{b}(CH)═(CH)(CH₂)_{c}CH₃, where b and c are each integers and b+c add to an integer between 8 and 23 (inclusive), preferably between and 16 (inclusive). The skilled artisan will further recognize that the hydrocarbon chain may include two or more unsaturations in alternate embodiments, although it is preferred to maintain unsaturations at 4 or less, more preferably 3 or less, most preferably 0, 1, or 2 (e.g., to minimize potential for oxidation of the surfactant, thereby maximizing thermal stability).

Specific examples of polysorbates include polysorbate 20 (polyoxyethylene (20) sorbitan monolaurate); polysorbate 40 (polyoxyethylene (20) sorbitan monopalmitate); polysorbate 60 (polyoxyethylene (20) sorbitan monostearate); and polysorbate 80 (polyoxyethylene (20) sorbitan monooleate). The 20, 40, 60, and 80 following “polysorbate” indicate the type of fatty acid moiety (the “lipophilic tail” of the molecule) appended to the polyoxyethylene sorbitan moiety (the “hydrophilic head” of the molecule): 20 is monolaurate, 40 is monopalmitate, 60 is monostearate, and 80 is monooleate (an example of a mono-unsaturated fatty acid moiety). The “polysorbate #” names assume 20 oxyethylene moieties [that is, —(CH₂CH₂O)—] appended to the sorbate. The alternate detailed names (e.g., “polyoxyethylene (20) sorbitan monostearate”) indicate the number of oxyethylene moieties substituted on the sorbitan (20) and the fatty acid moiety appended to one of those moieties (monostearate).

In certain embodiments, the surfactant can be or can comprise one or more of polysorbate 20, polysorbate 40, polysorbate 60, and/or polysorbate 80. For instance, the surfactant can be or can comprise polysorbate 60.

Commercially available examples include Avapol™ 60K from Avatar Corporation (polysorbate 60); Tween™ 20 detergent from Sigma-Aldrich or Tween™ 20 Surfact-Amps detergent solution from Thermo Scientific™; and Tween™ 40 viscous liquid from Sigma-Aldrich (also known as food additive number E434 in the European Union).

Also or instead, a surfactant that is a variant of the particular polysorbates just described may be employed. For example, referring again to Formula I, two, three, or all of R¹-R⁴ can each be a straight chain fatty acid moiety (with the remainder of R¹—R⁴, if any, being hydrogen). An example of this class of compound includes polyoxyethylene sorbitan tristrearate, in which three of R¹ to R⁴ are the fatty acid moiety stearate, and the other of R¹ to R⁴ is hydrogen.

Finally, it is reiterated that in other embodiments, sorbitan esters may be employed in a polymer composition as a surfactant-based PPA. Referring to Formula (I), w, x, y, and z would each be 0 (meaning no oxyethylene moieties are present). An example of such a compound is sorbitan tristearate, in which x, w, y, and z are each 0; three of R¹ to R⁴ are the fatty acid moiety stearate, and the other of R¹ to R⁴ is hydrogen.

### Amounts of Surfactant-Based PPA and Polymer Properties

The surfactant can be deployed in the polymer composition in amounts of at least 200 ppm, preferably at least 400 ppm, and more preferably at least 500 ppm or at least 600 ppm. For instance, it can be deployed in an amount within a range from a low of any one of 400, 500, 600, 650, 700, 750, 800, 900, 950, 1000, 1100, 1250, and 1500 ppm to a high of any one of 800, 900, 1000, 1100, 1200, 1300, 1400, 1500, 1600, 1700, 1800, 1900, 2000, 2500, 3000, 3500, 4000, 4500, and 5000 ppm, with ranges from any foregoing low to any foregoing high contemplated, provided the high end is greater than the low end (e.g., 600 to 1200 ppm, or 600 to 1600 ppm, or 600 to 800 ppm, or 1200 to 1700 ppm). The ppm values for surfactants and other additives described herein, unless specifically noted otherwise, are all based on mass of the polymer composition (i.e., inclusive of polymer plus surfactant, as well as any and all other additives in the polymer composition).

According to certain embodiments, it may be particularly advantageous to deploy the surfactant in a polymer composition comprising one or more polymers having particular rheology characteristics. For instance, according to some embodiments, the polymer of the polymer composition has MI of 5.0 g/10 min or less, preferably 2.5 g/10 min or less, such as 1.0 g/10 min or less, or within the range from 0.1, 0.2, or 0.5 g/10 min to 1.0, 1.2, or 1.5 g/10 min (with ranges from any low to any high contemplated).

Melt index ratio (MIR) is another polymer characteristic of potential interest in this regard. MIR is herein defined as the ratio of high load melt index (HLMI) (determined per ASTM D1238 at 190° C., 21.6 kg loading) to melt index, or HLMI/MI. Polymers of some embodiments can have MIR within the range from 10, 12, or 15 to 20, 25, or 30. In yet other embodiments, MIR may be greater than 30, such as within the range from 35 or 37 to 60, 65, 70, 75, 80, 85, 90, 95, or 100. More generally, polymers of MIR within the range from any foregoing low to any foregoing high (e.g., 10 to 65, such as 12 to 60) are contemplated in various embodiments.

Also or instead, density of the polymer may in some embodiments be within the range from 0.905 to 0.945 g/cm³, such as within the range from a low of any one of 0.905, 0.907, 0.908, 0.910, 0.911, 0.912, 0.913, 0.914, or 0.915 g/cm³ to a high of any one of 0.916, 0.917, 0.918, 0.919, 0.920, 0.924, 0.926, 0.930, 0.935, 0.940 or 0.945 g/cm³, with ranges from any foregoing low to any foregoing high contemplated herein (e.g., 0.910 to 0.925 or 0.935 g/cm³, such as 0.912 to 0.925, or 0.915 to 0.918 g/cm³). In yet other embodiments, the polymer may be of higher density (e.g., HDPE), having density within the range from 0.945 g/cm³ to 0.970 g/cm³.

In various embodiments, the surfactant may be deployed in the polymer composition in amounts that vary according to some of the polymer's properties, and in particular its MI and/or MIR. This can be the case, for example, with some polyethylene polymers. Relatively more of the surfactant-based PPA can be employed with polymer having relatively lower MI and/or higher MIR (which may indicate the presence of some degree of long-chain branching, particularly in polyethylenes such as LLDPEs). For instance, where the polymer composition includes a polyethylene (and especially mLLDPE) having melt index less than 1 g/10 min (e.g., within the range from 0.1 to 0.4, 0.5, 0.6, or 0.7 g/10 min) and MIR greater than 30 (e.g., within the range from 30, 35, or 37 to 60, 65, 70, 75, 80, 85, 90, 95, or 100), a concomitantly greater amount of the surfactant may be deployed as a PPA. More generally, the lower the MI of a polymer (and in particular a polyethylene polymer), the greater the anticipated amount of surfactant should be deployed as a PPA in the polymer composition. It is also believed that higher MIR may also in general suggest that a larger amount of surfactant should be deployed as a PPA in the polymer composition. Thus, methods in accordance with the present disclosure (discussed in more detail below) can deploy varying amounts of surfactant to a polymer composition, wherein said amounts vary proportionally to the MIR of the polymer, and/or vary inversely with the MI of the polymer.

Giving some examples, where MIR is greater than 30 (e.g., 30, 35, or 37 to 60 or 65), and/or MI is less than 1 g/10 min (e.g., from 0.1 to 0.5, 0.6, or 0.7 g/10 min), then the desired amount of surfactant in the polymer composition may be greater than 750 ppm, or preferably 900 ppm or more, such as 1000 ppm or more. Of course, once an adequate amount of surfactant is found for providing PPA benefits (e.g., prevention of melt fracture), it may be preferable not to exceed that amount needlessly, so the surfactant may be deployed within the range from 800 or 900 ppm to 1000 or 1100 ppm.

That said, a further sub-class of these low-MI, high-MIR polymers (and especially polyethylene polymers such as mLLDPE) may be identified, such that for MIR greater than 45 and/or MI less than 0.4 g/10 min (e.g., within the range from 0.1 to 0.4 g/10 min), an even greater amount of surfactant may be deployed as PPA, e.g., greater than or equal to 1200 ppm, such as within the range from 1200, 1300, 1400, or 1500 ppm to 1800, 2000, 2200, 2500, or 3000 ppm.

Thus, a more general class of polymer (and especially polyethylene polymer such as mLLDPE) may be taken as those having melt index greater than 0.4 g/10 min (such as within the range from 0.4 to 1.2 g/10 min) and MIR less than 45 (e.g., within the range from 10 to 45). For such polymer, surfactant can be deployed at about 600 to 1200 ppm, preferably within the range from a low of any one of about 500, 600, 700, 750, 800, or 850 ppm to a high of any one of about 1000, 1050, or 1100 ppm (with any foregoing low to any foregoing high contemplated).

### Methods

Methods in accordance with various embodiments include adding surfactant (according to the above description) to a polymer product (e.g., polymer granules and/or slurry) exiting a polymerization reactor to form a pre-finished polymer mixture in or upstream of a compounding extruder. The pre-finished polymer mixture therefore includes the polymer and surfactant-based PPA (both per above respective descriptions), as well as any optional other additives (which may be provided to the mixture along with, before, or after the surfactant). The pre-finished polymer mixture may, for example, be a polymer melt (e.g., formed in or just upstream of a compounding extruder). The mixture is then extruded and optionally pelletized to form a further polymer composition (e.g., polymer pellets) comprising the surfactant-based PPA(s) and polymer (each per above, and with the surfactant in amounts in accordance with the above discussion), as well as any optional other additive(s).

Also or instead, methods may include mixing finished polymer (e.g., polymer pellets) with surfactant to form a polymer article mixture; and processing the polymer article mixture to form a film. Such processing may be in accordance with well-known methods in the art, and in particular in accordance with blown film extrusion.

Returning to embodiments related to compounding extrusion (e.g., as part of a finishing process to produce the polymer composition), methods in accordance with the present disclosure may be employed to line-up proper surfactant dosing with different polymer grades, e.g., as may be produced as part of a polymer production campaign.

Such methods can include: at a first time, obtaining a first polymer reactor product from a polymerization reactor, the polymer reactor product having a first MIR and first MI; mixing a first portion of a surfactant-based PPA with the first polymer reactor product in a first surfactant amount (the surfactant being in accordance with the above-discussed surfactants) to form a first pre-finished polymer mixture; and extruding and optionally pelletizing the first pre-finished polymer mixture, thereby obtaining a first product comprising first finished polymer (e.g., first polymer pellets). Further, at a second time after the first time, a second polymer reactor product having second MI lower than the first MI (optionally, also or instead having MIR greater than the first MIR) is obtained from the polymerization reactor; and a second portion of the surfactant-based PPA is mixed with the second polymer reactor product in a second surfactant amount that is greater than the first surfactant amount. This forms the second pre-finished polymer mixture, which is extruded and optionally pelletized to form the second product comprising second finished polymer (e.g., second polymer pellets).

In methods of such embodiments, either or both of the first pre-finished polymer mixture and the first finished polymer product can be in accordance with the polymer compositions (comprising polymer and surfactant-based PPA) discussed herein. Likewise, either or both of the second pre-finished polymer mixture and the second finished polymer product can also be in accordance with the polymer compositions discussed herein.

In particular embodiments, the first polymer reactor product has MI greater than 0.45 g/10 min, and the second polymer reactor product has MI less than 0.45 g/10 min. Optionally, the first polymer reactor product can have MIR less than 45; and the second polymer reactor product can have MIR greater than 45. Further, the first surfactant amount can be within the range from 500, 600, 700, or 750 ppm to 1000, 1050, 1100, 1150, or 1200 ppm; and the second surfactant amount can be within the range from 1000 ppm to 3000 ppm, such as from 1000, 1100, or 1200 to 1600, 1800, 2000, 2500, or 3000 ppm.

### Other Additives

As noted, other additives optionally can also be present in the polymer composition (e.g., antioxidants, stabilizers such as UV stabilizers, catalyst neutralizers, and other additives known in the art of polymerization). Where such additives are employed, they are also preferably free or substantially free of fluorine. Further, it is reiterated that where other additives are present, the mass of such additives is included in the denominator for determining the ppm loading amounts for surfactant-based PPA described herein (that is, the ppm loading is on the basis of total mass of polymer+PPA+other additives).

### EXAMPLES

To facilitate a better understanding of the embodiments of the present invention, the following examples of preferred or representative embodiments are given.

Blown film trials were conducted on two blown film extruder lines, L1 and L2, to demonstrate a general usage of the inventive PPA formulations. Both lines were operated using a mono film annular die with the following conditions: a blowup ratio of 2.5, a die temperature set point of 390° F., a film gauge of 3 mil, a die gap of 30 mil, and a frost line height of 5 times the die diameter. L1 has a die diameter of 160 mm, while L2 has a die diameter of 51 mm.

### Example 1

Initially for preparing for the trials on line L1, the L1 film line extruder was fed with a blend of a preceding polyethylene (labeled herein as P19, a generic commercial LLDPE with an additive package containing a phenolic antioxidant, a phosphite-based secondary antioxidant, and a catalyst neutralizer) with Polybatch® KC 30 (a polyethylene-based cleaning and purging compound from A. Schulman, Inc.) in a 2:1 weight ratio (of preceding PE to KC cleaning compound) for at least 30 minutes. The purpose of this initial step was to remove contaminants and potential PPAs from the metal surfaces inside the extruder and die.

Then, the film line was stopped and the inner die was manually polished to remove the KC 30 material.

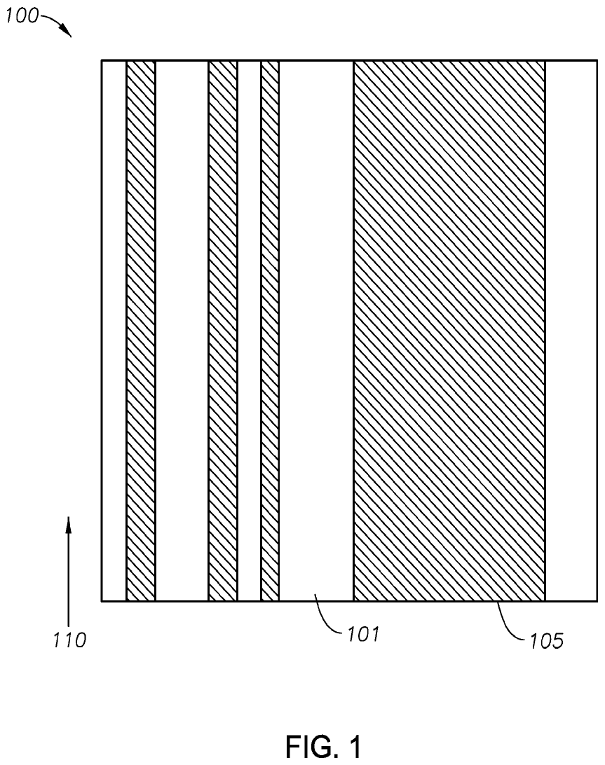

Third, the inner die was reinserted and the line was resumed for the trial runs. An mLLDPE with density=0.918, MI=1.0 g/10 min, and MIR=16 (including the additive package containing a phenolic antioxidant, a phosphite-based secondary antioxidant, and a catalyst neutralizer) was fed through L1 for 1 hour, until any residual KC 30 was removed and melt fracture developed on the entirety of the film surface made from the mLLDPE. Fourth, a conventional fluoropolymer-containing PPA (DYNAMAR™ FX5929M) was fed to the extruder at constant mass flow rate which matched the mass flow rate of the mLLDPE. As PPA was fed, the melt fractures slowly began to disappear in streaks as illustrated in FIG. 1. With reference to FIG. 1, as the PPA is added, melt fracture-free regimes begin to emerge as stripes 101 in the machine direction 110 of the film 100 (that is, the direction in which the film is extruded and blown). FIG. 1 is a schematic conceptually illustrating this transitory period with streaks 105 of melt-fractured film material, and the stripes 101 of melt fracture-free film. Over time, these stripes 101 grow in width and the melt fracture zones diminish, and are eventually eliminated completely. This trial, using the mLLDPE noted and the conventional PPA, is denoted as C1 in Table 1 below. Table 1 summarizes the PPA used in each trial, identifies the preceding polyethylene used for initial cleaning of the extruder and die, and provides the die factor and specific output through the extruder in each trial run.

The process was repeated for trial run I1, which took place in the same manner as described above for trial run C1, and using the same mLLDPE, except the inventive polysorbate PPA was used at the amount indicated in Table 1, instead of the conventional PPA used in trial run C1. And the process was again repeated for trial runs I2, I3, and I4, each using the polysorbate PA, but in increasing amounts as indicated in Table 1. Table 1 also indicates the die factor of the extruder L1, which is the mass flow rate of the polymer divided by the annular die circumference (this measures mass flux, which can affect shear stresses experienced by the polymer and thus its proneness to melt fractures); and further indicates the specific output, which is the mass flow rate of the polymer divided by the rotation speed of the extruder screw (major reductions to this value for a given resin would indicate an extrusion flow inefficiency, potentially caused by problems such as excessive slippage or back-flow inside the extruder).

TABLE 1
Inventive and comparative examples on Line L1 for Example 1

| | | | | | | | Specific |
|---|---|---|---|---|---|---|---|
| | | PE | PE MI | | | Die Factor | Output |
| | | density | (g/10 | PE | Prec. | (lbs./hr.- | (lbs./hr.- |
| Run | PPA formulation | (g/cm³) | min) | MIR | PE | in. die) | rpm) |
| C1 | 400 ppm | 0.918 | 1.0 | 16 | P19 | 10 | 5.9 |
| | Dynamar ™ | | | | | | |
| | FX5929M | | | | | | |
| I2 | 500 ppm | 0.918 | 1.0 | 16 | P19 | 10 | 6.5 |
| | Avapol ™ 60K | | | | | | |
| I3 | 750 ppm | 0.918 | 1.0 | 16 | P19 | 10 | 6.0 |
| | Avapol ™ 60K | | | | | | |
| I4 | 1000 ppm | 0.918 | 1.0 | 16 | P19 | 10 | 6.7 |
| | Avapol ™ 60K | | | | | | |

For each trial run, the time at which PPA feed was begun was recorded as time T=0, and extent of melt fracture on each extruded film was observed as a percentage of the surface area of the film including melt-fracture streaks (see FIG. 1 and discussion above) versus duration of PPA feed.

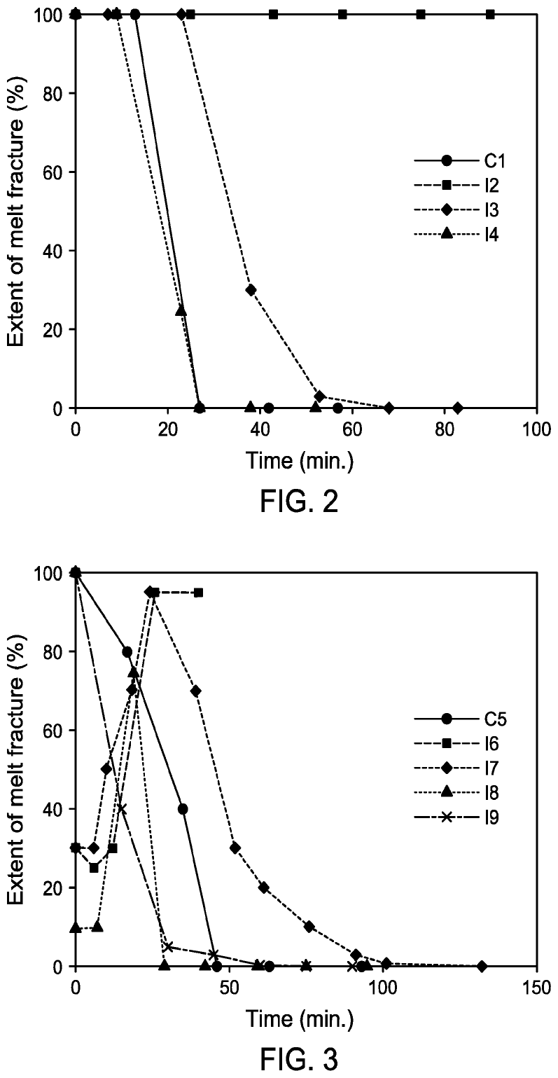

FIG. 2 is a plot showing the extent of melt fracture (starting at 100% and, ideally, progressing to 0%) as a function of time after time T=0 (i.e., as a function of time after PPA feed was resumed to the extruder). In this manner, effectiveness of the PPAs could be judged in eliminating melt fracture in the resulting blown films. From FIG. 2, it can be seen that 12 (having only 500 ppm of the polysorbate PPA) did not achieve melt fracture reduction during the 100 minutes of observation post-PPA initiation. On the other hand, 750 ppm of the polysorbate PPA achieved complete elimination of the melt fractures within 70-80 minutes, comparing favorably with the 27-minute complete elimination of melt fractures achieved by the fluorine-containing PPA. And finally, 14, incorporating 1000 ppm of the polysorbate PPA, achieved virtually the same (if not slightly better) rapid elimination of melt fractures as compared to the fluorine-containing PPA, showing a successful replacement of the incumbent PPA with this fluorine-free alternative.

### Example 2

The same process was carried out on Line L2 with the different die diameter (including use of preceding PE with Polybatch® KC 30 for at least 30 minutes, serving the same clean-out step as noted above; stopping the line and removing the die for cleaning; and then reinserting the die and resuming the line). Further, the same mLLDPE (density=0.918 g/cm³, MI=1.0 g/10 min, MIR=16) with same additive package (lacking PPA) was used. Again, the first run was carried out with the conventional fluoropolymer-containing PPA, and the run is labeled C5 in Table 2 below. Follow-up runs I6, I7, and I8 were repeated, each using inventive polysorbate PPA (Avapol™ 60K) in increasing amounts as indicated in Table 2 below. And, follow-up run 19 was carried out in the same manner, with 1000 ppm of inventive PPA, except using the mLLDPE (with no PPA or catalyst neutralizer) as the preceding PE (labeled as P20 in Table 2), instead of the LLDPE P19 used in previous runs. This helped confirm that the identity of the preceding PE (and its additive package, containing catalyst neutralizer) did not affect melt fracture elimination.

TABLE 2
Inventive and comparative examples on Line L2 for Example 2

| | | | | | | | | Specific | |
|---|---|---|---|---|---|---|---|---|---|
| | | PE | PE MI | | | Die Factor | Corr. | Output | Corr. |
| | PPA | density | (g/10 | PE | Prec. | (lbs./hr.- | Die | (lbs./hr.- | Spec. |
| Run | formulation | (g/cm³) | min) | MIR | PE | in. die) | Fact.* | rpm) | Output* |
| C5 | 400 ppm | 0.918 | 1.0 | 16 | P19 | — | — | — | — |
| | Dynamar ™ | | | | | | | | |
| | FX5929M | | | | | | | | |
| I6 | 250 ppm | 0.918 | 1.0 | 16 | P19 | 2.9 | 4.3 | 1.0 | 1.5 |
| | Avapol ™ 60K | | | | | | | | |
| I7 | 750 ppm | 0.918 | 1.0 | 16 | P19 | 2.4 | 3.7 | 0.8 | 1.3 |
| | Avapol ™ 60K | | | | | | | | |
| I8 | 1000 ppm | 0.918 | 1.0 | 16 | P19 | 2.0 | 3.2 | 0.7 | 1.1 |
| | Avapol ™ 60K | | | | | | | | |
| I9 | 1000 ppm | 0.918 | 1.0 | 16 | P20 | 3.2 | 3.6 | 1.2 | 1.3 |
| | Avapol ™ 60K | | | | | | | | |

*Corrected Die Factor has same units as Die Factor; and Corrected Specific Output has same units as Specific Output

Again, for each trial run, the time at which PPA feed was initiated was recorded as time T=0, and extent of melt fracture on each extruded film was observed as a percentage of the surface area of the film including melt-fracture streaks (see FIG. 1 and discussion above) versus duration of PPA feed. In addition, corrected die factor and corrected specific output are reported, which reflect adjustments made to recognize a systematic calibration inaccuracy in the L2 tachometer reading (which under-reported line speed in feet per minute; which was used in conjunction with film sample weight and film sample length over time to determine total output of film mass over time). As can be seen in Table 2, the initial systematic under-reporting meant that die factor and specific output values for all samples is increased in corrected form, such that the same conclusions of relative output for all samples can still be drawn. Note that similar corrected die factor and specific output are reported in Tables 3 and 4 below, again with the result that the same conclusions regarding relative outputs for all samples can be drawn.

FIG. 3 is a plot showing the extent of melt fracture as a function of time after time T=0 (i.e., as a function of time after PPA feed was resumed to the extruder) for blown films in trial runs C5 and I6-I9. It is noted that in FIG. 3, melt fracture for some runs starts at less than 100%; this is because the preceding PE (P19) used for some of these runs is not as prone to developing melt fractures as the mLLDPE (used as preceding P20 and used in all the trial runs). While the much higher die factor line L1 (used in Example 1) still led to 100% melt fractures in Example 1, the use of lower die factor L2 in Example 2 meant the mass flux was not sufficient for the polyethylene in each case to develop 100% melt fracture in the run-time leading up to the trial. Still, the tests were a valid comparison of melt fracture prevention, since within the first 10-15 minutes of switching to the PPA feed, the PPA did not have time to fully develop on the die (hence the increase in melt fractures during this time period). But, once the PPA had time to coat the die, the melt fracture is observed to decrease as expected (where the PPA is working successfully). Thus, again, effectiveness of the PPAs could be judged in eliminating melt fracture in the resulting film by comparing the extent that melt fracture was eliminated after sufficient time with flowing PPA. Further, as with Example 1, it can be seen that sufficiently high loading of the polysorbate PPA achieves complete elimination of all melt fractures on the differently sized die of Line L2, with 750 ppm achieving slower elimination (around the 130-140 minute mark), and 1000 ppm loading achieving complete elimination within about 40 to 60 minutes, comparing favorably to the incumbent fluorine-based PPA's approximately 50-minute elimination time.

### Example 3

Potential effects of resin characteristics were investigated. The same process was again carried out on L2, but with a different mLLDPE (density=0.923 g/cm³, MI=0.48 g/10 min, MIR=40), and using only two trial runs: C10, employing 500 ppm Dynamar™ FX5929M, and I11, using 1000 ppm Avapol™ 60K. Then, a further different mLLDPE (density=0.938 g/cm³, MI=0.28 g/10 min, MIR=58) was used for runs C12 and I13, which were, like respective runs C10 and C11, carried out using 500 ppm Dynamar™ FX5929M (C12) and 1000 ppm Avapol™ 60K (I13). Table 3 summarizes these trial runs. P21 in Table 3 references the mLLDPE used for runs C10 and I11, which was also used as the preceding PE for cleaning the line prior to the trial runs (and had no catalyst neutralizer or other PPA); similarly, P22 indicates the mLLDPE used for runs C12 and C13, and also used as the preceding PE before those runs (again having no catalyst neutralizer or other PPA).

TABLE 3
Inventive and comparative examples on Line L2 for Example 3

| | | | | | | | | Specific | |
|---|---|---|---|---|---|---|---|---|---|
| | | PE | PE MI | | | Die Factor | Corr. | Output | Corr. |
| | | density | (g/10 | PE | Prec. | (lbs./hr.- | Die | (lbs./hr.- | Specific |
| Run | PPA formulation | (g/cm³) | min) | MIR | PE | in. die) | Fact.* | rpm) | Output* |
| C10 | 500 ppm | 0.923 | 0.48 | 40 | P21 | 3.9 | 5 | 1.1 | 1.4 |
| | Dynamar ™ | | | | | | | | |
| | FX5929M | | | | | | | | |
| I11 | 1000 ppm | 0.923 | 0.48 | 40 | P21 | 3.6 | 4.7 | 1.0 | 1.3 |
| | Avapol ™ 60K | | | | | | | | |
| C12 | 500 ppm | 0.938 | 0.28 | 58 | P22 | 3.7 | 4.8 | 1.1 | 1.4 |
| | Dynamar ™ | | | | | | | | |
| | FX5929M | | | | | | | | |
| I13 | 1000 ppm | 0.938 | 0.28 | 58 | P22 | 3.4 | 4.3 | 1.0 | 1.2 |
| | Avapol ™ 60K | | | | | | | | |

*Corrected Die Factor has same units as Die Factor; and Corrected Specific Output has same units as Specific Output

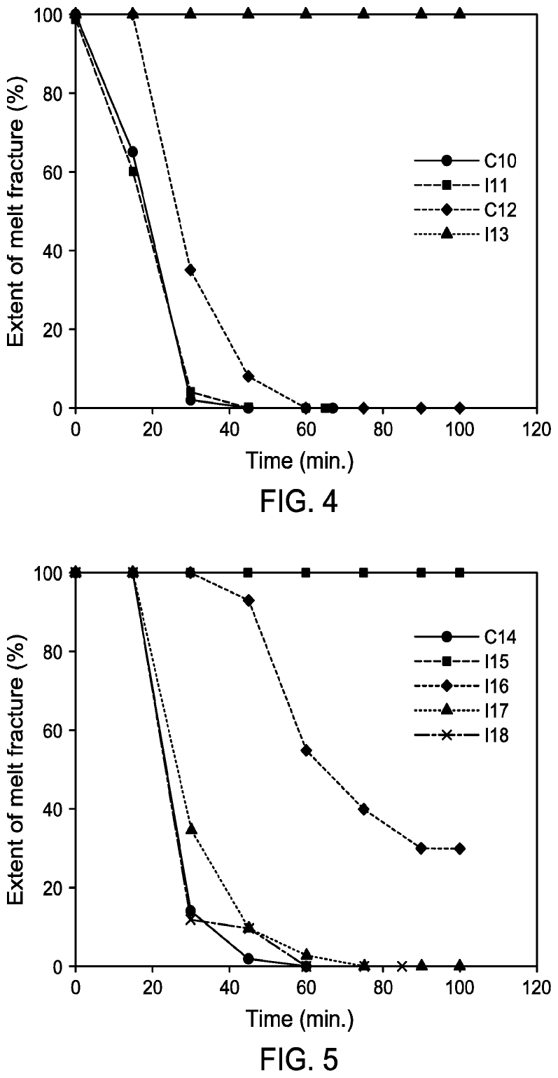

FIG. 4 is a plot showing the extent of melt fracture (starting at 100% and, ideally, progressing to 0%) as a function of time after time T=0 (i.e., as a function of time after PPA feed was resumed to the extruder) for the blown films formed in trial runs C10, I11, C12, and I13. In this manner, effectiveness of the PPAs could be judged in eliminating melt fracture in the resulting film, in view of the polymer resin to which the PPA was added. An interesting observation arises: both mLLDPE resins used in these trials (one in C10 and I11, the other in C12 and I13) are very low MI (less than 1), and have slight long chain branching causing MIR to be relatively high (greater than 30). However, while the mLLDPE used in trial run I11 experienced successful elimination of melt fracture with 1000 ppm of the Avapol™ 60K, the mLLDPE of trial run I13 experienced no reduction in melt fractures with the same loading during the entire 120 minutes of observation after initiation of PPA feed to the extruder. This suggests that Avapol™ 60K loading for lower MI and/or higher MIR polymer (as is the case with the mLLDPE of run I13) might need to be even higher.

### Example 4

Another mLLDPE with lower melt index and moderately higher MIR was tested for elimination of melt fractures with the polysorbate PPA in line L2. Specifically, the mLLDPE of the trial runs reported in Example 4 has density 0.915 g/cm³; MI of 0.48 g/10 min; and MIR of 29. This same mLLDPE was used as the preceding PE to clean the line L2 prior to each trial run, in the same procedure as described above. Each trial run was also carried out using the same procedure as described above.

Table 4 reports the PPA identity and loading of each run, as well as the properties of the PE used, die factor, and specific output from the extruder L2.

TABLE 4
Inventive and comparative examples on Line L2 for Example 4

| | | | | | | | | Specific | |
|---|---|---|---|---|---|---|---|---|---|
| | | PE | PE MI | | | Die Factor | Corr. | Output | Corr. |
| | PPA | density | (g/10 | PE | Prec. | (lbs./hr.- | Die | (lbs./hr.- | Specific |
| Run | formulation | (g/cm³) | min) | MIR | PE | in. die) | Fact.* | rpm) | Output* |
| C14 | 500 ppm | 0.915 | 0.48 | 29 | P23 | 3.3 | 4.3 | 1.1 | 1.4 |
| | Dynamar ™ | | | | | | | | |
| | FX5929M | | | | | | | | |
| I15 | 500 ppm | 0.915 | 0.48 | 29 | P23 | 3.3 | 4.2 | 1.1 | 1.4 |
| | Avapol ™ 60K | | | | | | | | |
| I16 | 1000 ppm | 0.915 | 0.48 | 29 | P23 | 3.0 | 3.8 | 1.0 | 1.3 |
| | Avapol ™ 60K | | | | | | | | |
| I17 | 1250 ppm | 0.915 | 0.48 | 29 | P23 | 3.8 | 4.8 | 1.2 | 1.6 |
| | Avapol ™ 60K | | | | | | | | |
| I18 | 1500 ppm | 0.915 | 0.48 | 29 | P23 | 3.5 | 4.5 | 1.2 | 1.5 |
| | Avapol ™ 60K | | | | | | | | |

*Corrected Die Factor has same units as Die Factor; and Corrected Specific Output has same units as Specific Output

FIG. 5 reports the times required for elimination of melt fractures in the blown films for each run. In this case, it is observed that substantially more polysorbate PPA is required to achieve melt fracture elimination—with 1250 ppm loading achieving a somewhat slower elimination as compared to the incumbent fluoropolymer-containing PPA (˜90 minutes vs. ˜60 minutes), and 1500 ppm being required to achieve similarly quick melt fracture elimination (˜60 minutes). 1000 ppm and 500 ppm loadings did not fully eliminate the melt fractures during the 100 minutes of observation.

### Example 5

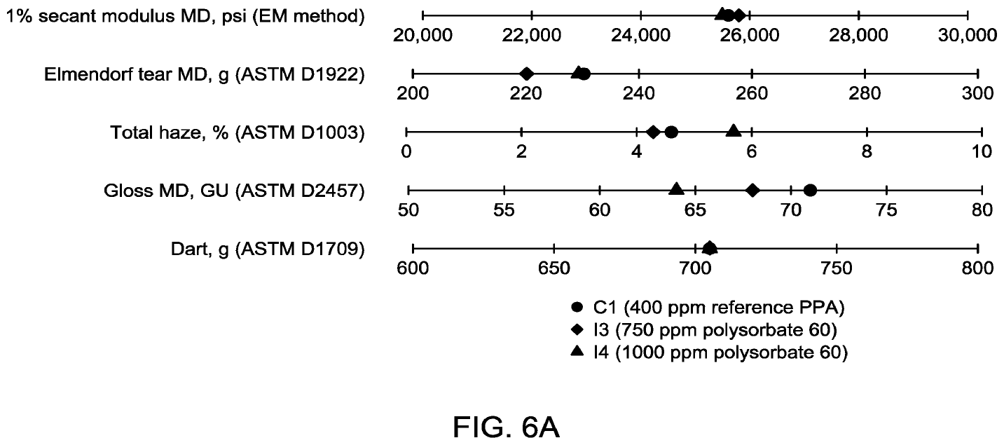

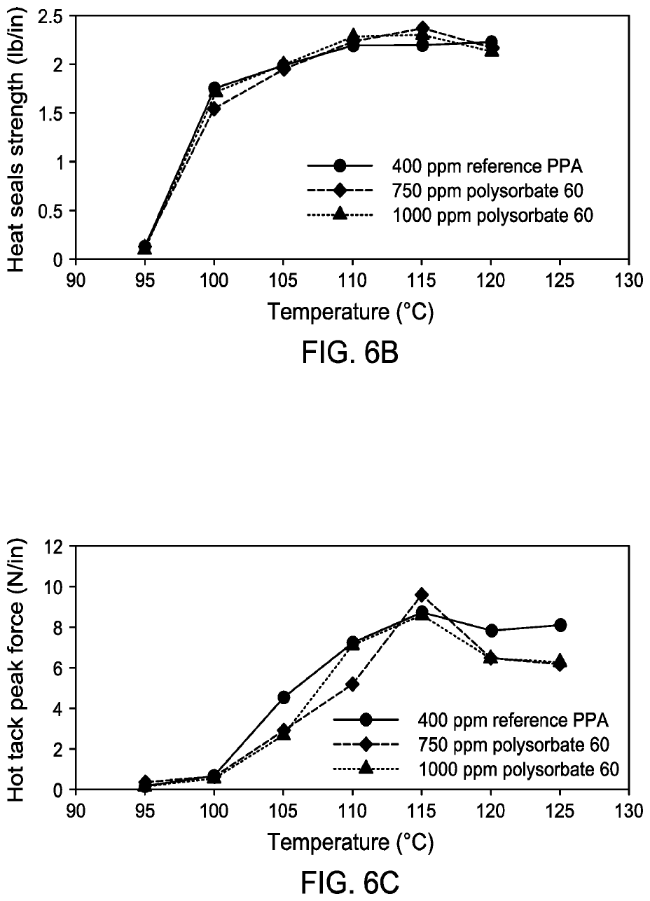

The example films from runs C1, I3, and I4 (see Table 1) were collected and tested for various properties, so as to confirm whether the films made using surfactant-based PPA (runs I3, I4) compare favorably to films made using the incumbent fluoropolymer-containing PPA (run C1). FIG. 6a is a chart showing the similarity of the following properties:
1% secant modulus (Machine Direction, or MD, and measured in psi), in which I3 and I4 are within approximately +/−1% of the value for C1. The “secant modulus” is the slope of a line connecting the origin to an object's stress/strain curve at a specified strain percentage. For example, the “1% secant modulus” is the slope of a line connecting the origin to an object's stress/strain curve at 1% strain. The secant modulus describes the overall stiffness of an object. Lower strain percentages typically approximate elastic behavior more accurately. It can be determined by ASTM D882.
Elmendorf tear (MD, g), in which I4 is nearly identical to C1, and in which I3 exhibits slightly lower tear (but still within 5%) of C1. Elmendorf tear is determined per ASTM D1922.
Total haze (%), in which I3 actually exhibits less haze than C1, I4 exhibits approx. 25% greater haze than C1; however, all haze values are still suitably low (under 6%). Haze is determined per ASTM D1003.
Gloss (MD, measured in Gloss Units or GU), in which all samples are within about 64 to about 71 GU, such that I3 and I4 are within about +/−10% of the gloss of C1.
Dart (g), in which all samples have a virtually equal value (e.g., within +/−0.1%).

Similarly, FIGS. 6b and 6c show the similar curves for heat seal strength and hot tack peak force, respectively, vs. temperature, illustrating that heat seal and tack properties are substantially similar among the inventive and comparative films.

### DISCUSSION

Thus, the invention can also be embodied in a film made from any of the above-described polymer compositions (and in particular, polyethylene compositions) comprising the polymer and the surfactant-based PPA (e.g., polysorbate PPA), and preferably being substantially free of fluorine; wherein the film has one or more of (and preferably all of):
1% secant modulus (MD) within +/−5% psi, preferably within +/−1% psi, of the value (psi) of a film that is made using a fluoropolymer-based PPA instead of the surfactant-based PPA, but is otherwise identical;
Elmendorf tear (MD) within +/−10% g, preferably within +/−5% g, of the value (g) of a film that is made using a fluoropolymer-based PPA instead of the surfactant-based PPA, but is otherwise identical;
Total haze within +/−25%, preferably within +/−10%, of the value (in %) of a film that is made using a fluoropolymer-based PPA instead of the surfactant-based PPA, but is otherwise identical, and/or total haze less than 6%;
Gloss (MD) within +/−12%, preferably within +/−10%, of the value (in GU) of a film that is made using a fluoropolymer-based PPA instead of the surfactant-based PPA, but is otherwise identical; and
Dart within +/−1%, preferably within +/−0.5% or even within +/−0.1%, of the value (g) of a film that is made using a fluoropolymer-based PPA instead of the surfactant-based PPA, but is otherwise identical.

In the discussion above, a film “made using a fluoropolymer-based PPA instead of the surfactant-based PPA, but is otherwise identical” is intended to mean that a film made using an effective amount of surfactant-based PPA is compared against a film made using an effective amount of fluoropolymer-based PPA; not necessarily that the same amount of each PPA is used. An effective amount is such that visible melt fractures are eliminated from the film, consistent with the discussion in connection with Example 1.

By way of further discussion of the above Examples, it is noted that Example 3 saw moderately low MI, high MIR polyethylene, with which the polysorbate surfactant worked well as a PPA with 1000 ppm loading; while the surfactant did not work as well when employed in an extremely-low MI (but still high MIR) polyethylene. Example 4 deals with a polyethylene with moderately low MI and moderately high MIR, wherein the surfactant still worked well as a PPA, but required increased loading.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

While the present disclosure has been described with respect to a number of embodiments and examples, those skilled in the art, having the benefit of this disclosure, will appreciate that other embodiments can be devised which do not depart from the scope and spirit of the present disclosure.

We claim:

1. A polymer composition comprising:
a C₂-C₆ olefin homopolymer or a copolymer of two or more C₂-C₂₀ α-olefins; and
from 200 to 5000 ppm (on the basis of mass of the polymer composition) of a surfactant comprising a hydrophilic head and a lipophilic tail.

2. The polymer composition of claim 1, wherein the surfactant is a sorbitan ester or a polysorbate.

3. The polymer composition of claim 2, wherein the surfactant comprises the polysorbate.

4. The polymer composition of claim 3, wherein the polysorbate has the structural formula (I): 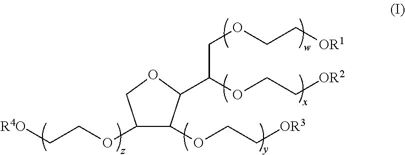
where one of R¹-R⁴ is a straight chain fatty acid moiety, and the other three of R¹-R⁴ are each hydrogen; and w, x, y, and z are integers such that 10≤w+x+y+z≤40.

5. The polymer composition of claim 4, wherein the straight chain fatty acid moiety is of the formula (C═O)(CH₂)CH₃, where a is an integer between 10 and 25.

6. The polymer composition of claim 5, wherein the surfactant comprises polysorbate 20, polysorbate 40, polysorbate 60, polysorbate 80, or combinations thereof.

7. The polymer composition of claim 6, wherein the surfactant comprises polysorbate 60.

8. The polymer composition of claim 1, wherein the polymer composition comprises an ethylene copolymer comprising units derived from ethylene and units derived from one or more C₃ to C₂₀ α-olefins.

9. The polymer composition of claim 8, wherein the ethylene copolymer is metallocene-catalyzed linear low density polyethylene (mLLDPE), comprising units derived from ethylene and units derived from 1-butene, 1-hexene, or 1-octene.

10. The polymer composition of claim 8, wherein the ethylene copolymer has density within the range from 0.905 to 0.945 g/cm³ and melt index (ASTM D1238 at 190° C., 2.16 kg loading) within the range from 0.1 to 5.0 g/10 min.

11. The polymer composition of claim 1, wherein the polymer composition comprises the surfactant within a range from 500 to 2000 ppm, on the basis of mass of the homopolymer or copolymer.

12. The polymer composition of claim 11, wherein the polymer composition comprises the surfactant within a range from 700 to 1500 ppm.

13. The polymer composition of claim 10, wherein:
(A) the ethylene copolymer has melt index within the range from 0.4 to 1.2 g/10 min and/or melt index ratio (MIR, the ratio of high load melt index (ASTDM D1238 at 190° C., 21.6 kg loading) to melt index) within the range from 10 to 25; and
(B) the polymer composition comprises the surfactant within a range from 700 to 1100 ppm, on the basis of mass of all homopolymer or copolymer present in the polymer composition.

14. The polymer composition of claim 10, wherein:
(A) the ethylene copolymer has melt index less than 0.4 g/10 min and/or melt index ratio (MIR, the ratio of high load melt index (ASTDM D1238 at 190° C., 21.6 kg loading) to melt index) greater than 25; and
(B) the polymer composition comprises the surfactant within a range from 1200 to 2000 ppm, on the basis of mass of all homopolymer or copolymer present in the polymer composition.

15. The polymer composition of claim 1, wherein the polymer composition is substantially free of fluorine.
